(19) United States
(12) Patent Application Publication
(10) Pub. No.: US 2006/0153025 A1
(43) Pub. Date: Jul. 13, 2006

(54) Recording medium recording control method and recording control device

(76) Inventors: Kenichi Iiida, Tokyo (JP); Jun Yasuda, Tokyo (JP); Kazuyuki Takaoka, Tokyo (JP)

Correspondence Address: WOLF GREENFIELD & SACKS, PC;NULL, FEDERAL RESERVE PLAZA, 600 ATLANTIC AVENUE, BOSTON, MA, 02210-2206, US

(21) Appl. No.: 10/545,488

(22) PCT Filed: Jan. 27, 2004
(86) PCT No.: PCT/JP04/00695

§ 371 Date: Aug. 12, 2005

(30) Foreign Application Priority Data
Feb. 20, 2003 (JP) 2003-042983

(51) Int. Cl. G11B 5/09

(52) U.S. Cl. 369/47.1; 369/53.1

(57) ABSTRACT

The present invention is directed to a recording control method for performing write operation of data with respect to a recording medium in which small block having a predetermined number of data is caused to be unit of read/write operation of data, erasing operation of data can be performed at large block consisting of plural small blocks, write operation of small block unit can be performed at random between large blocks and between small blocks, and write operation of small blocks within large block is performed in address order, wherein when write operation of small blocks within large block has been completed, there is discriminated whether or not small block to be subsequently written is the same as large block within which the small block in which write operation has been completed is included, and address of small block to be subsequently written has address order posterior to address of the small block in which write operation has been completed. If so, write operation of the small block to be subsequently written is executed.

### TECHNICAL FIELD

The present invention relates to a recording control method and a recording control apparatus for a recording medium such as flash memory, etc.

This Application claims priority of Japanese Patent Application No. 2003-042983, filed on Feb. 20, 2003, the entirety of which is incorporated by reference herein.

### BACKGROUND ART

Recording data handled by NAND type flash memory is caused to be of the configuration as shown in FIG. 1, for example. Namely, recording data is read out and written in units of small block called page, and is erased in units of large block called block consisting of plural pages.

One page consists of, e.g., data area of 512 bytes, and spare area (redundant part) of 16 bytes. 4 (four) bytes of the spare area of 16 bytes are used as ECC (Error Correction Code) for detecting/correcting error.

Read/write control operations of the flash memory are performed by a method as described in, e.g., the Japanese Patent Application Laid Open No. 2000-31104 publication.

A recording control apparatus adapted for controlling read operation and write operation of the flash memory is adapted to perform, by logical address, management of physical address of the flash memory in which data have been written on block basis. For this reason, the recording control apparatus has logical/physical address conversion table for performing conversion between physical address and logical address of the flash memory on the block basis. The recording control apparatus performs address control of the flash memory by using the logical/physical address conversion table.

In this case, logical addresses are written into spare areas of respective pages. Moreover, updating flag indicating whether or not write operation into block of corresponding logical address is being performed is included in the spare area. When the write operation is being performed, the updating flag is turned ON (“0”), while when the write operation is not being performed, the updating flag is placed in ON (“1”) state.

Then, the write operation of data of page unit in the NAND type flash memory will be explained. In this case, in the NAND type flash memory, block to be written and page to be written can be determined at random, but there is the restriction that, in write processing procedure within the same block, such determination must be performed in accordance with the address order from the leading page of address number. Namely, it is required to perform write operation in order from page having small address within the same block. For this reason, hitherto, even in the case of write operation of page unit, write operation is performed in units of block including corresponding page to be written.

FIG. 2 is a view for explaining the outline of write operation of data of the page unit.

Namely, in the case where page data is written into area corresponding to 1 (one) page which is empty within a certain block, space (empty) area corresponding to 1 (one) block is prepared to write new data into page address to be written of the space area, and to copy original data with respect to data of other pages of corresponding block. Further, after write processing has been completed, the original block is erased.

In FIG. 2, blocks to which slanting lines have been implemented indicate data written page in which data have been already written, blank blocks indicate data unwritten page in which data has not yet been written, and blocks to which meshing has been implemented indicate new data write page in which write operation of new data is performed.

FIG. 3 is a flowchart of processing operation at the time of writing data. In this flowchart, the processing that the previously described recording control apparatus adapted for controlling read/write operation of flash memory executes is mainly described.

Namely, the recording control apparatus discriminates whether or not write instruction into the flash memory takes place (step S1). When it is discriminated that the write instruction does not take place, the recording control apparatus executes other processing (step S2).

Further, when it is discriminated at the step S1 that write instruction has taken place, the recording control apparatus determines logical addresses of block to be written and page to be written (step S3) to allow the updating flag of the leading page of block of the corresponding logical address to be turned ON (step S4).

Then, block to be written is saved into spare space area prepared at logical/physical address conversion table of the recording control apparatus from a logical point of view, and space block area where block of which logical address is the same as logical address of the block to be written can be written is prepared (step S5). The processing of the step S5 will be further explained with reference to FIG. 4.

Namely, it is assumed, as shown in FIG. 4, for example, that the flash memory has, as valid area, logical block address A to logical block address A+n−1, and has spare area corresponding to 1 (one) block of logical block address A+n. Here, it is assumed that the spare area of the logical block address A+n has been already erased so that the spare area results in space area.

In the example shown in FIG. 4, block to be written is assumed to be block of logical block address A+3. In view of the above, in this example, at step S4, as shown in FIG. 4, updating flag of the spare area at the leading page of block of logical block address A+3 is turned ON.

At step S5, the recording control apparatus changes, on the logical/physical address conversion table, logical block address of block of logical block address A+3 which is block to be written into logical block address A+n of the spare area. At this time, rewrite operation of logical address of the spare area on the block data of the logical block address A+3 is not performed.

Moreover, logical block address of the spare area where logical block address was A+n is converted into A+3 on the logical/physical address conversion table. The reason why exchange (switching) of the logical address is performed is that A+3 is permitted to be written into logical address of spare area of block to be newly written. By exchange of the logical address, it seems as if original block data to be written is saved into spare area from a logical point of view so that logical block address where original block data to be written existed results in space area.

When the processing of the step S5 as described above has been completed, the recording control apparatus copies, in a manner indicated as \textcircled{1}-1 in FIG. 2, all page data of the address order prior to page to be written from original block to be written into corresponding page of block area of write destination (step S6). At this time, updating flag of the spare area of the leading page of block of copy destination is turned OFF.

Then, as indicated by \textcircled{1}-2 of FIG. 2, the recording control apparatus serves to write data of page to be written into corresponding page of block area of write destination (step S7).

Then, as indicated by \textcircled{1}-3 of FIG. 2, the recording control apparatus copies all page data having address order posterior to page to be written from original block to be written into corresponding page of block area of write destination (step S8).

When rewrite operations have been completed in connection with data of all pages of original block to be written in a manner as stated above, the recording control apparatus serves to erase data of original block to be written which has been saved in the spare area from a logical point of view (step S9). Thus, the spare area from a logical point of view results in space area.

Then, the recording control apparatus discriminates whether or not write operation has been completed (step S10). When the write operation has not yet been completed, processing returns to the step S3 to determine block to be subsequently written and page to be subsequently written to repeat the above-mentioned processing. Moreover, when it is discriminated at the step S10 that write operation has been completed, this write processing routine is completed.

When power supply voltage is interrupted for the reason such as power failure (interruption) and/or dying of the battery, etc. in the middle of write processing as stated above, there would result the state where write operation is not completed. In order to cope with such case, reset processing is conventionally performed at the time when power supply voltage is turned ON for a second time to take a measure such that inconvenience does not take place from a viewpoint of address management of the flash memory.

FIG. 5 is a flowchart for explaining reset processing when power supply voltage is turned ON for a second time.

Namely, when the power supply voltage is turned ON for a second time, the recording control apparatus starts reset processing shown in FIG. 5 to search logical addresses of spare areas of the leading pages of respective blocks to discriminate whether or not two blocks of the same logical address exist (step S21).

As previously described, since logical address of the spare area on page data of original block to be rewritten which has been saved into the spare area from a logical point of view remains to be original address, there results the same state as that of the logical address of the spare area on the page data of block of rewrite destination. Accordingly, when power is interrupted in the middle of write processing, two same blocks in which logical address is the same would exist. It is to be noted that since updating flag is in ON state within original block to be rewritten, it is possible to make discrimination between corresponding block and block of rewrite destination where updating flag is in OFF state.

When it is discriminated on the basis of the above-mentioned facts at the step S21 that two blocks where the logical address is the same exist, it is judged that power supply has been interrupted in the middle of write processing to left data of blocks in which updating flag is in ON state among those two blocks, and to all erase data of blocks where updating flag is in OFF state (step S22). Thus, the system state returns to the state before page write processing. Further, the reset processing is completed to shift to the subsequent processing.

Further, it is discriminated at the step S21 that only one block in which logical address is the same exists, the reset processing is completed as it is under the judgment where there is no data in which write processing is being performed to shift to the subsequent processing.

In a manner as stated above, in the conventional recording control method for flash memory, all pages of one block are rewritten into block of write destination every time write operation of data of 1 (one) page is performed (including copy), and original block to be written is erased.

Accordingly, since write operation of data of 1 (one) page involves write operation and erase operation of block unit, there is the problem in the conventional recording control method for flash memory that write processing speed is low.

### DISCLOSURE OF THE INVENTION

An object of the present invention is to provide a novel recording control method and a novel recording apparatus for a recording medium which can solve problems that prior arts as described above have.

Another object of the present invention is to provide a recording control method which permits write processing speed to be high as a recording control method for a recording medium such as flash memory, and a recording control apparatus therefor.

The present invention proposed in order to attain objects as described above is directed to a recording control method for a recording medium in which small block having a predetermined number of data is caused to be unit of read/write operation of data, and large block consisting of the plural small blocks is caused to be unit of erasing operation of data so that write operation of the small blocks within the large block is performed in address order, the recording control method comprising: writing data into a first small block within the large block; discriminating whether or not a second small block to be subsequently written has address order posterior to address of the first small block within the large block; and writing data into the second small block when it is discriminated that the second small block has address order posterior to address of the first small block within the large block.

Moreover, the present invention is directed to a recording control method for a recording medium in which small block having a predetermined number of data is caused to be unit of read/write operation of data, and large block consisting of the plural small blocks is caused to be unit of erasing operation of data so that write operation of the small blocks within the large block is performed in address order, the recording control method comprising: a first copying step of copying small block having address order prior to address of a first small block at a first large block within which the first small block is included into corresponding address of a second large block in which data has been erased; a first writing step of writing data into address corresponding to address of the first small block of the second large block; a discrimination step of discriminating whether or not a second small block to be subsequently written has address order posterior to address of the first small block within the first large block; a second copying step in which when it is discriminated at the discrimination step that the second small block has address order posterior to address of the first small block within the first large block, data of the small block between the first small block and the second small block is copied into corresponding address of the second large block; a second writing step of writing data into address corresponding to address of the second small block of the second large block after the second copying step; a third copying step in which when it is discriminated at the discrimination step that the second small block is small block within a large block different from the first large block, data of all small blocks having address order posterior to address of the first small block of the first large block are copied into corresponding address of the second large block; and an erasing step of erasing data of the first block after the third copying step, wherein there are performed, at the time of return operation after write processing has been interrupted on the way, a step of detecting small block address having the order most ahead among small block addresses which are empty in succession when viewed from small block address in which address order is the last within the second large block, a step of copying data of corresponding small block of the first large block into all small block addresses subsequent to small block address of the order most ahead of the second large block, and an erasing step of erasing data of the first large block.

Further, at the time of return operation after write operation of small block unit is interrupted on the way, small block address having the order most ahead among large block addresses which are empty in succession when viewed from small block address in which address order is the last of the second large block is caused to be small block address where write operation is to be subsequently started within the second large block.

Further, the present invention is directed to a recording control apparatus for a recording medium in which small block having a predetermined number of data is caused to be unit of read/write operation of data, and large block consisting of the plural small blocks is caused to be unit of erasing operation of data so that write operation of the small blocks within the large block is performed in address order, the recording control apparatus comprising: discriminating means adapted so that when write operation of data into a first small block within the large block is completed, the discriminating means serves to discriminate whether or not a second small block to be subsequently written is small block within the large block, and has address order posterior to address of the first small block, whereby when it is discriminated at the discriminating means that the second small block is small block within the first large block, and has address order posterior to address of the first small block, write operation of data is performed into the second small block.

Further, the present invention is directed to a recording control apparatus for a recording medium in which small block having a predetermined number of data is caused to be unit of read/write operation of data, and large block consisting of the plural small blocks is caused to be unit of erasing operation of data so that write operation of the small blocks within the large block is performed in address order, the recording control apparatus comprising: first copying means for copying small block having address order prior to address of a first small block at a first large block within which the first small block is included into address corresponding to a second large block in which data has been erased; first writing means for writing data into address corresponding to address of the first small block within the second large block; discriminating means for discriminating whether or not a second small block to be subsequently written has address order posterior to address of the first small block within the first large block; second copying means adapted so that when it is discriminated by the discriminating means that the second small block has address order posterior to address of the first small block within the first large block, the second copying means serves to copy small block data between the first small block and the second small block into corresponding address of the second large block; second writing means for writing data into address corresponding to address of the second small block within the second large block in which copy has been made by the second copying means; third copying means adapted so that when it is discriminated by the discriminating means that the second small block is small block within a large block different from the first large block, the third copying means serves to copy all small block data having address order posterior to address of the first small block within the first large block into corresponding address of the second large block; and erasing means for erasing data of the first large block after copy processing at the third copying means.

The recording control apparatus according to the present invention further comprises: detecting means for detecting that write operation of small block unit has been interrupted on the way; means adapted so that when it is detected by the detecting means that write operation of small block unit has been interrupted on the way, the last-mentioned means detects small block address having the order most ahead among small block addresses which are empty in succession when viewed from small block address in which address order is the last within the second large block; copying means for copying data of corresponding small block of the first large block into all small block addresses subsequent to small block address having the order most ahead of the second large block; and erasing means for erasing data of the first large block.

The recording control apparatus according to the present invention further comprises detecting means for detecting that write operation of small block unit has been interrupted on the way, whereby when it is detected by the detecting means that write operation of small block unit has been interrupted on the way, small block address having the order most ahead among small block addresses which are empty in succession when viewed from small block address in which address order is the last of the second large block is caused to be small block address in which write operation is to be subsequently started within the second large block.

Still more further objects of the present invention and practical merits obtained by the present invention will become more apparent from the description of the embodiments which will be given below with reference to the attached drawings.

### BRIEF DESCRIPTION OF THE DRAWINGS

FIG. 1 is a view showing data structure of NAND type flash memory.

FIG. 2 is a view for explaining a conventional recording control method with respect to the NAND type flash memory.

FIG. 3 is a flowchart showing procedure of the conventional recording control method with respect to the NAND type flash memory.

FIG. 4 is a view for explaining the conventional recording control method with respect to the NAND type flash memory.

FIG. 5 is a flowchart showing procedure of reset processing in the conventional recording control method for recording medium.

FIG. 6 is a block diagram showing the configuration of IC recorder to which a recording control method for a recording medium according to the present invention is applied.

FIG. 7 is a view for explaining memory area structure of flash memory.

FIGS. 8 and 9 are portions of flowchart showing procedure of a recording control method for a recording medium according to the present invention.

FIG. 10 is a view for explaining the recording control method for recording medium according to the present invention.

FIG. 11 is a flowchart showing procedure of reset processing in the recording control method for recording medium according to the present invention.

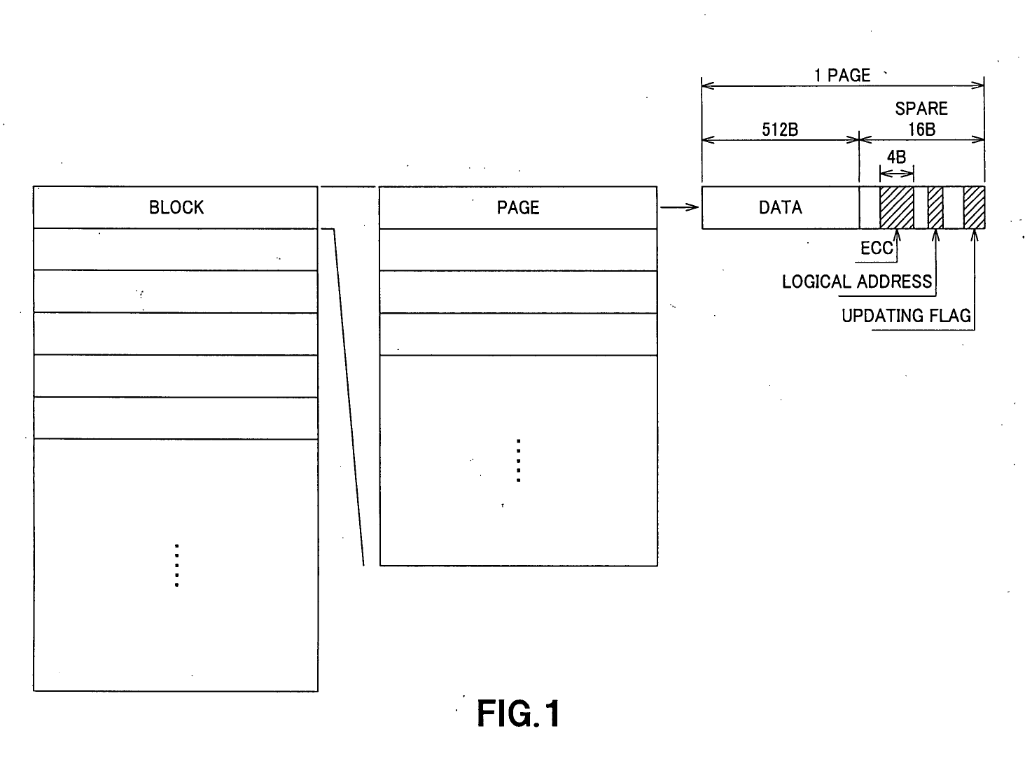

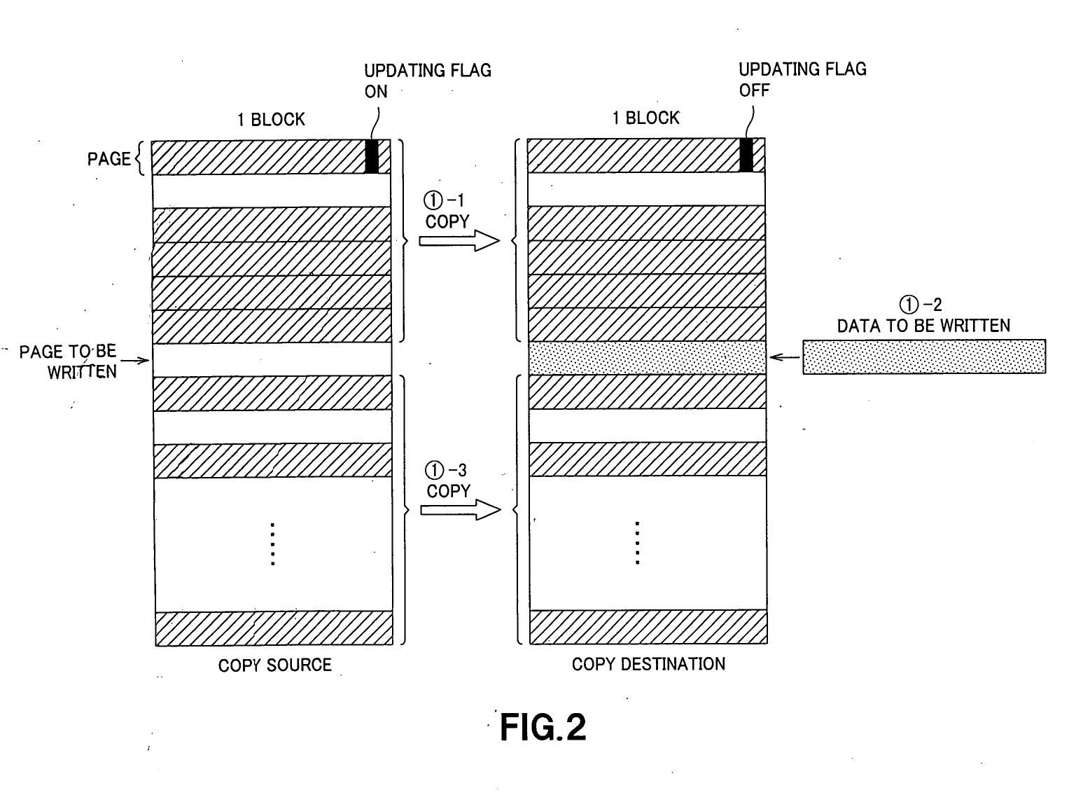

### BEST MODE FOR CARRYING OUT THE INVENTION

Explanation will now be given by taking the example of the case where a recording control method and a recording control apparatus for a recording medium according to the present invention are applied to an IC (Integrated Circuit) recorder.

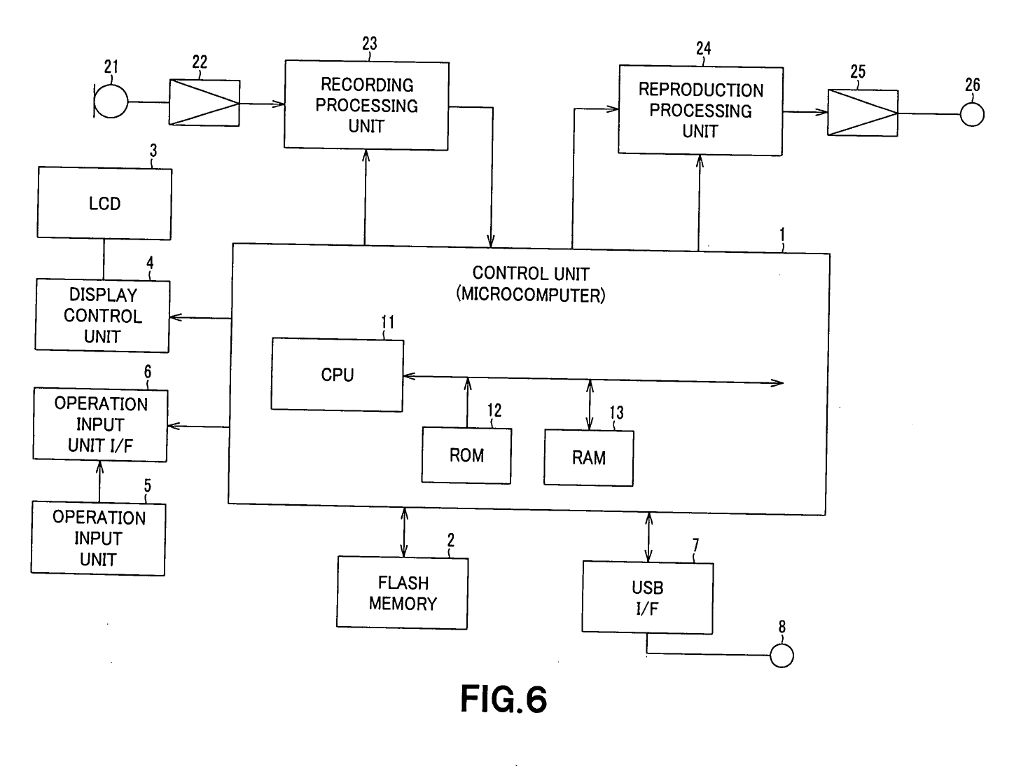

FIG. 6 is a block diagram showing the configuration of the IC recorder to which the present invention is applied.

In the IC recorder shown in FIG. 6, a flash memory 2 serving as a recording medium, a display control unit 4 for performing display control with respect to a LCD (Liquid Crystal Display) 3 as an example of the display device, an operation input unit interface 6 for connecting an operation input unit 5 to a control unit 1, and a USB (Universal Serial Bus) interface 7 are connected to the control unit 1 constituted by microcomputer.

In this example, the microcomputer constituting the control unit 1 includes therewithin a CPU (Central Processing Unit) 11, a program ROM (Read Only Memory) 12, and a RAM (Random Access Memory) 13 for work area. There may be also used a microcomputer in which the program ROM 12 and the work area RAM 13 are externally connected with respect to the CPU.

The constituent portion composed of the control unit 1 and the flash memory 2 serves as a portion constituting the embodiment of the recording control apparatus for recording medium.

In the IC recorder of this example, an audio signal from a microphone 21 is delivered to a recording processing unit 23 through an amplifier 22. Under control by the control unit 1, the recording processing unit 23 serves to convert the audio signal into a digital signal, and performs data compression.

When the control unit 1 receives recording instruction from the operation input unit 5 through the operation input unit interface 6, it receives audio data from the recording processing unit 23 to write the audio data thus received into the flash memory 2. When the control unit 1 receives reproduction instruction from the operation input unit 5 through the operation input unit interface 6, it reads out audio data from the flash memory 2 to send out the audio data which has been read out to a reproduction processing unit 24. Under control by the control unit 1, the reproduction processing unit 24 decompresses (expands) received compressed audio data, and converts a digital audio signal back into an analog audio signal. Further, the reproduction processing unit 24 delivers, through an amplifier 25, the analog audio signal to an audio signal output terminal to which, e.g., earphone is connected. In addition, the control unit 1 performs a predetermined display on the screen of the LCD 3 through the display control unit 4.

In the IC recorder of this example, e.g., personal computer can be connected to a USB connector 8 through USB cable. Further, the control unit 1 reads out audio data recorded in the flash memory 2 to perform data transfer thereof to the personal computer through the USB interface 7, and is supplied with data from the personal computer through the USB interface 7 to have ability to write such data into the flash memory 2.

Moreover, in this example, with respect to audio data to be written into the flash memory 2, management thereof can be made every matters or things to be done. With respect to audio data every respective matters to be done, character comments can be added thereto. Those character comments can be displayed on the screen of the LCD 3.

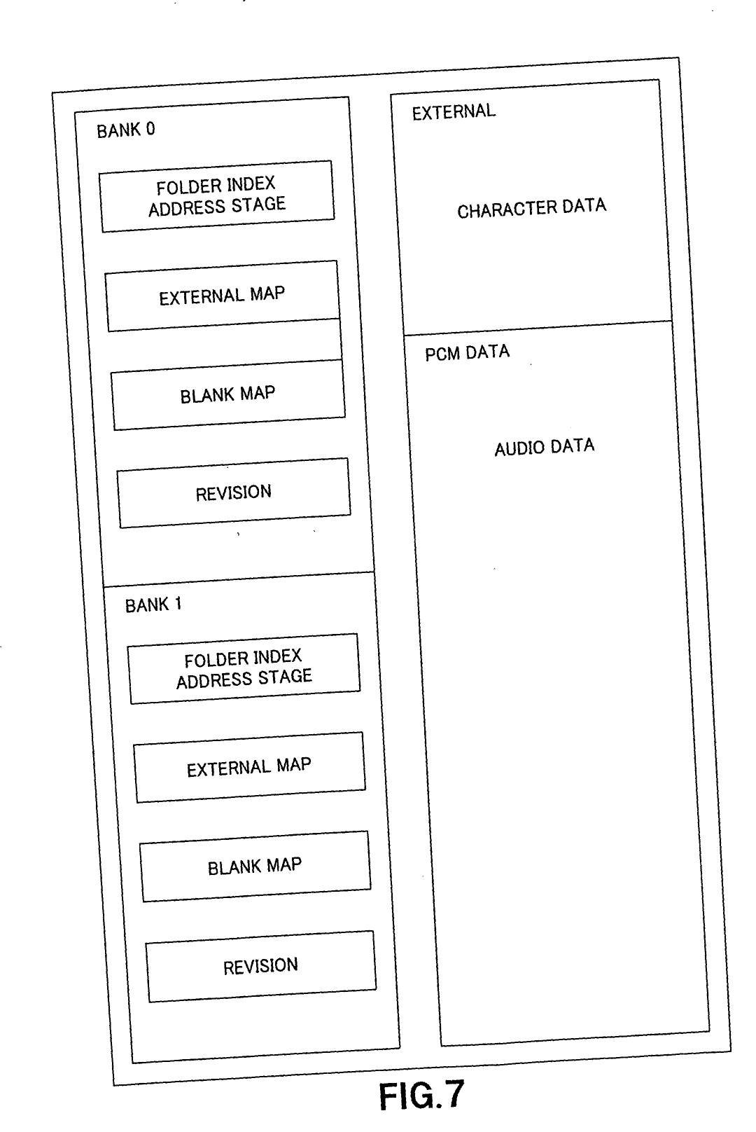

The memory area management in the flash memory 2 in this case will be explained. FIG. 7 is an explanatory view of the memory area of the flash memory 2 of this example. In FIG. 7, “BANK0” and “BANK1”, and “EXTERNAL” are TOC (Table of Contents) areas. Moreover, “PCM DATA” is an area where audio data are to be written.

“EXTERNAL” is an area where character comments are to be written. In this example, characters which can be inputted with respect to one matter to be done of audio data are caused to have 256 bytes, and are assigned to 1 (one) page. Namely, character comment corresponding to one matter to be done is assigned to 1 (one) page.

“BANK0” and “BANK1” respectively include “FOLDER INDEX ADDRESS STAGE”, “EXTERNAL MAP”, “BLANK MAP” and “REVISION”.

“FOLDER INDEX ADRESS STAGE” is adapted to store information for performing management of position of area of “PCM DATA” where audio data every respective matters to be done exist (page unit), and position of area of “EXTERNAL” where character comment corresponding to the audio data exist (page unit).

“EXTERNAL MAP” is adapted to store information for performing management as to how character comment is written into the area of “EXTERNAL”, and as to page where space (empty) area exists.

“BLANK MAP” is adapted to store information as to how audio data is written in “PCM DATA”. “REVISION” serves to perform management of number indicating No. of revision times of “BANK0”, “BANK1”.

In the case of the IC recorder of this example, personal computer connected though the USB interface 7 is caused to have application software for writing character comments. In the application, write columns for charcter comment are displayed every respective large number of matters to be done stored in the flash memory 2 on picture of the personal computer. Thus, character comments are inputted into the write column.

Further, inputted data of character comment is transferred from the personal computer to the IC recorder through the USB interface 7. Thus, the control unit 1 serves to write transferred data of character comment into the area of “EXTERNAL” of the flash memory 2. In this case, the control unit 1 serves to search space (empty) area with reference to “EXTERNAL MAP” to write the character comment into the area of “EXTERNAL”. It is to be noted that, in this example, determination is made so as to perform write operation in the address number order, i.e., in order from space (empty) page area of the order ahead.

It should be noted that the reason why two areas of “BANK0” and “BANK1” exist is that TOC information before by one is stored into one area so that the operation state can return to the state before by one. Namely, even if power interruption suddenly takes place when TOC is being rewritten, rewritten BANK is one BANK so that the operation state can necessarily return to information of BANK in the state before by one where no rewrite operation is performed.

In addition, by referring the number of revision times stored in the area of “REVISION”, it is possible to recognize which of two areas of “BANK0” and “BANK1” is old or new.

Then, the write control of data into the flash memory 2 according to the present invention will be explained.

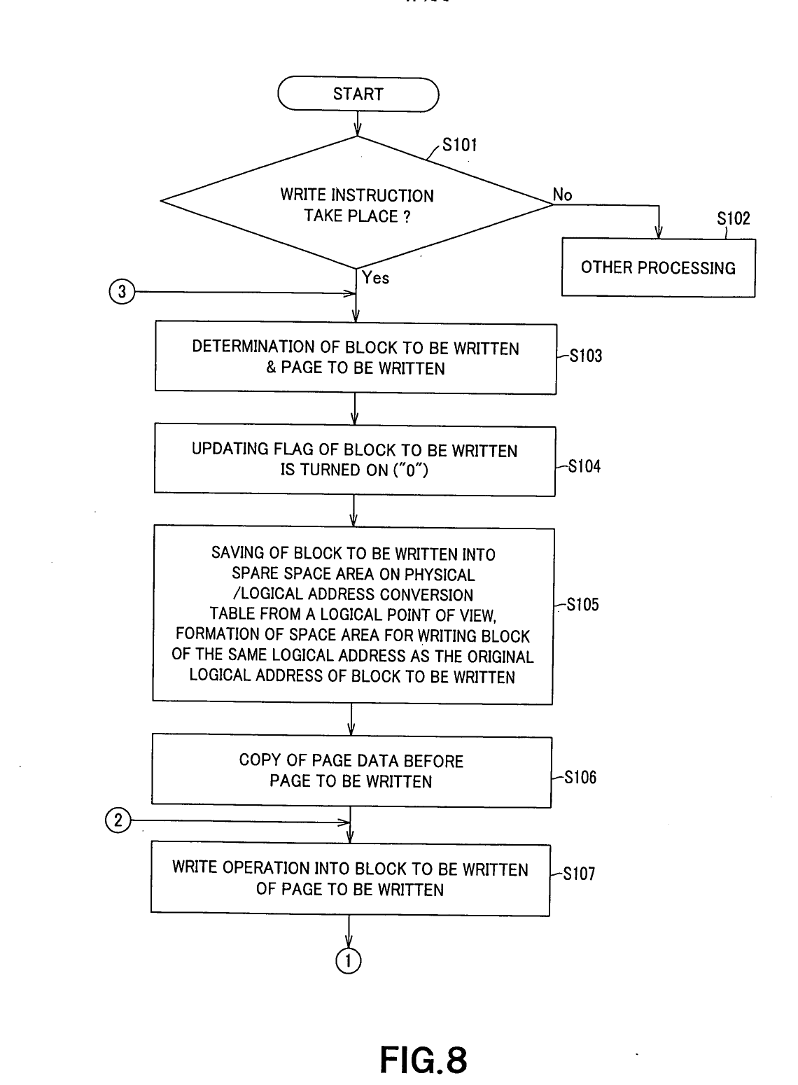

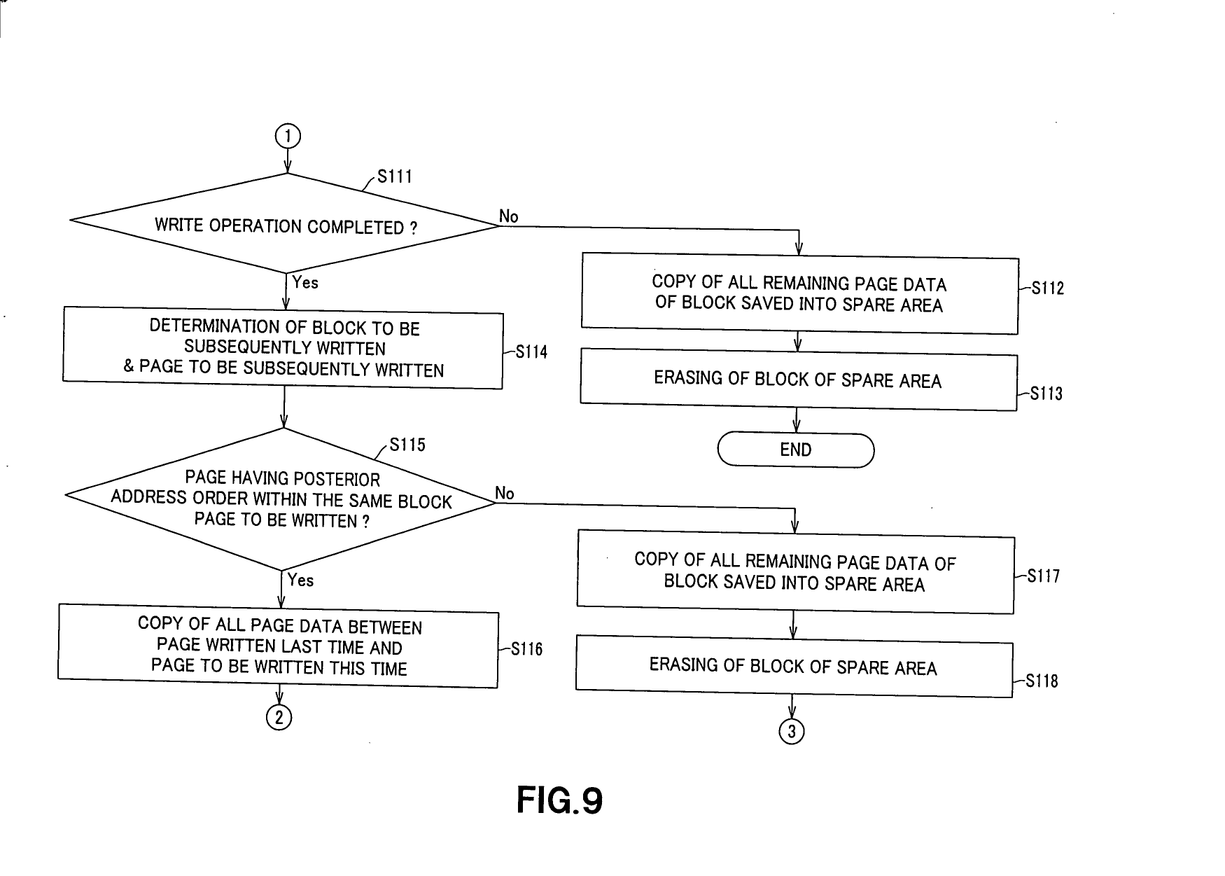

FIGS. 8 and 9 are flowchars of the processing operation at the time of data write operation into the flash memory 2 according to the prsesnt invention. In these flowcharts, the processing that the CPU 11 of the control unit 1 executes in accordance with program of the ROM 12 is mainly described.

Namely, the control unit 1 discriminates whether or not write instruction into the flash memory 2 takes place (step S101). When it is discriminated that write instruction does not take place, the control unit 1 executes other processing (step S102).

Further, when it is discriminated at the step S101 that write instruction has taken place, the control unit 1 determines logical addresses of block to be written and page to be written (step S103) to allow updating flag of the leading page of block of the logical address to be turned ON (step S104).

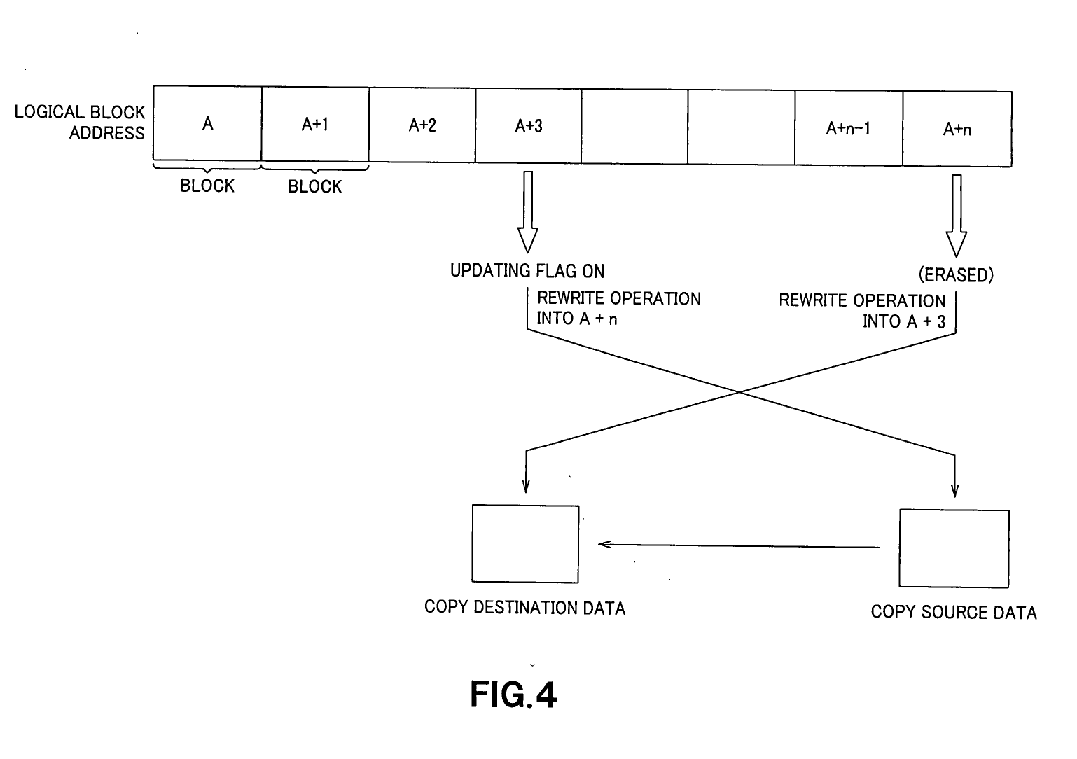

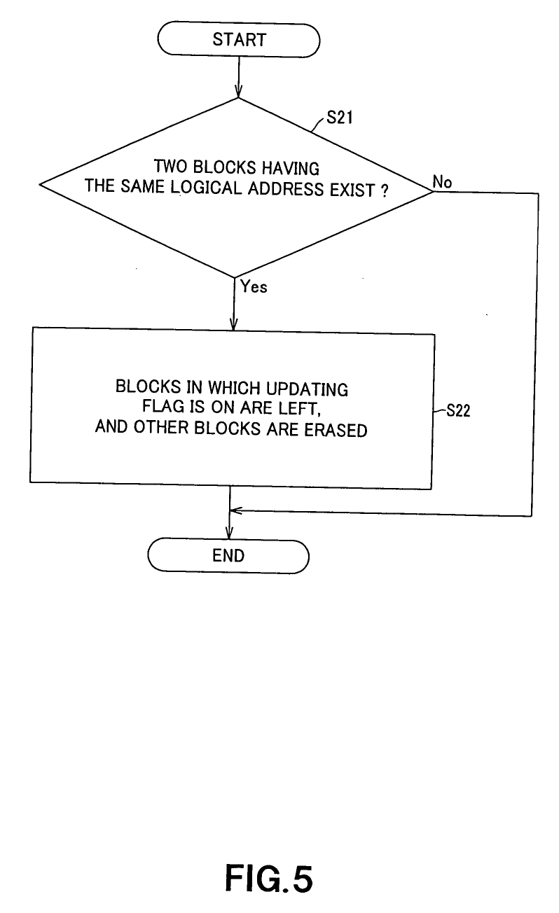

Then, block to be written is saved into spare space area prepared in the logical/physical address conversion table (existing within the RAM 12) of the control unit 1 from a logical point of view, and space block area where block having the same logical address as logical address of the block to be written can be written is prepared (step S105). The processing of this step S105 is executed in a manner explained with reference to the previously described FIG. 4.

Then, the control unit 1 copies all page data having address order prior to the page to be written from original block to be written into corresponding page of the block area of write destination (step S106). It is to be noted that, at this time, updating flag of the spare area of the leading page of block of copy destination remains to be in OFF state.

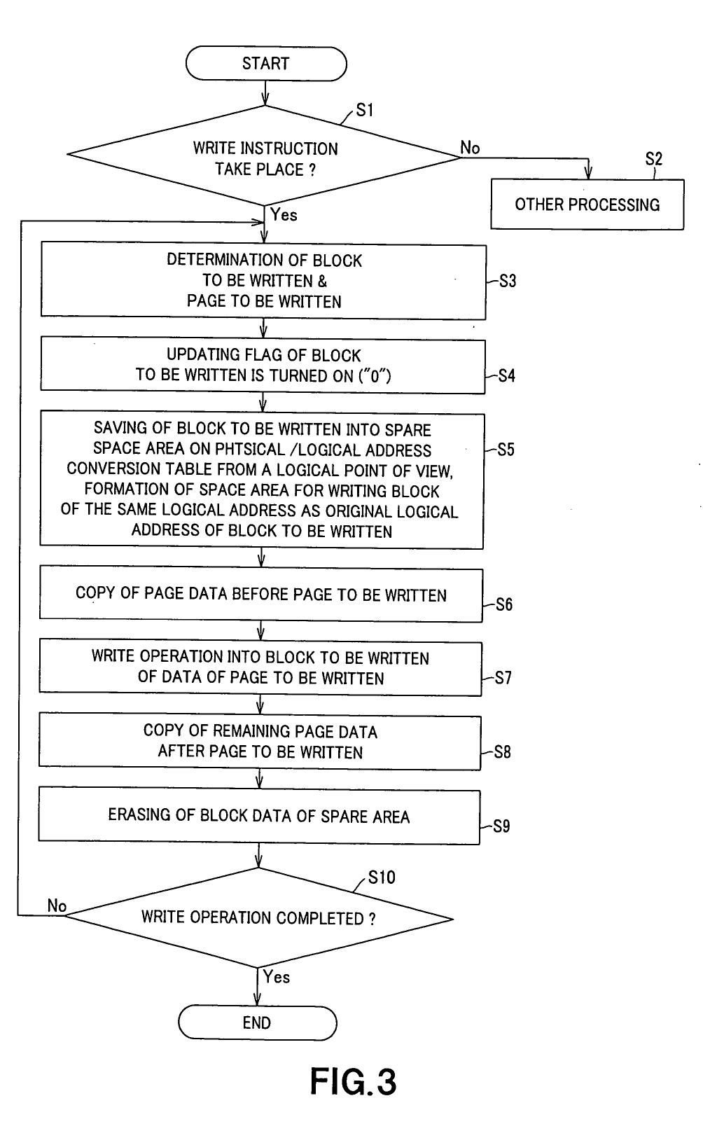

Then, the control unit 1 serves to write data of the page to be written into corresponding page of the block area of write destination (step S107). The processing up to the step S107 are similar to the processing up to the steps S1 to S7 of the flowchart of FIG. 3 which is the conventional write control procedure.

In the present invention, after write operation of the page data has been completed at the step S107, remaining pages after pages to be written are not immediately all copied as in the case of the prior art, but page immediately after write operation has been completed is registered as next write start position in the corresponding block. Thus, the system is brought into standby state.

In this standby state, whether or not write operation has been completed is discriminated (step S111 of FIG. 9). If the write operation is completed, data of all pages after page to be written are copied from the original block to be written into corresponding page of block area of write destination (step S112).

Further, when rewrite operation has been completed in connection with data of all pages of original block to be written, the control unit 1 serves to erase data of original block to be written which has been saved into the spare area from a logical point of view (step S113). Further, this write processing routine is completed.

Moreover, when it is discriminated at the step S111 that write operation has not yet been completed, the control unit 1 determines logical addresses of block to be subsequently written and page to be subsequently written (step S114). Further, there is discriminated whether or not determined page to be subsequently written is page within the same block being written, and has address of order backward (post-order) of page address which has been written at the step S107 (step S15).

When it is discriminated at the step S115 that page to be subsequently written is page within the same block being written, and is page of address position of the order backward (post-order) with respect to the page where data has been written last time, the control unit 1 copies data of all pages between page where data has been written last time and page to be subsequently written from original block to be written into corresponding page of block area of write destination (step S116).

Further, processing returns to the step S107 of FIG. 8 to perform write operation of data with respect to page to be written which has been determined at the step S114. At times subsequent thereto, for a time period during which page to be subsequently written is page within the same block being written, and is page of address position having order backward (post-order) with respect to page where data has been written last time, routine of steps S111 to S116, and returning from the step S116 to step S107 is repeated.

When it is discriminated at the step S115 that page to be subsequently written is not page within the same block being written, the control unit 1 copies data of all pages after last page to be written from original block to be written into corresponding page of block area of write destination (step S117).

Further, when rewrite operation has been completed with respect to data of all pages of original block to be written, the control unit 1 serves to erase data of the original block to be written which has been saved in the spare area from a logical point of view (step S118). Further, processing returns to the step S104 to repeat processing steps subsequent to the step S104.

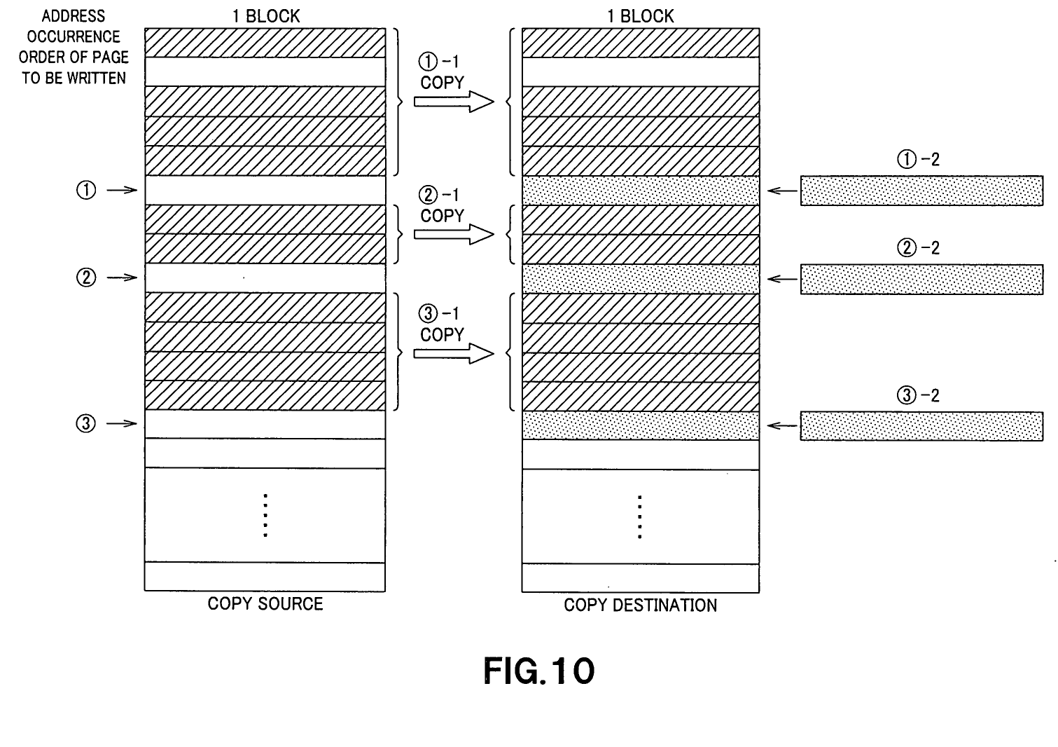

Accordingly, in the writing method according to the present invention, in the case where designation of page to be written is such that there results pages within the same block as indicated by \textcircled{1}, \textcircled{2}, \textcircled{3} in FIG. 10, and address order results in order backward (post-order) in succession, those pages of \textcircled{1}, \textcircled{2}, \textcircled{3} are written at a high speed in a manner as described below.

Namely, in write operation of the page of \textcircled{1}, page before page of \textcircled{1} is first copied from original block to be written (block of copy source) into block of write destination (block of copy destination) as indicated by \textcircled{1}-1 in FIG. 10. Thereafter, in FIG. 10, write operation of the page of \textcircled{1} is performed as indicated by \textcircled{1}-2 in FIG. 10.

Subsequently, all pages between page of \textcircled{1} and page of \textcircled{2} are copied from original block to be written (block of copy source) into block of write destination (block of copy destination) as indicated by \textcircled{2}-1 in FIG. 10. Thereafter, in FIG. 10, write operation of the page of \textcircled{2} is performed as indicated by \textcircled{2}-2.

Further, subsequently, all pages between the page of \textcircled{2} and the page of \textcircled{3} are copied from original block to be written (block of copy source) into block of write destination (block of copy destination) as indicated by \textcircled{3}-1 in FIG. 10. Thereafter, in FIG. 10, write operation of the page of \textcircled{3} is performed as indicated by \textcircled{3}-2 in FIG. 10.

In FIG. 10, blocks to which slanting lines have been implemented indicate data written page where data have been already written, blank blocks indicate data unwritten page where data have not yet been written, and blocks to which meshing has been implemented indicate new data write page where write operation of new data is to be performed.

In a manner as stated above, in accordance with the present invention, unlike the conventional method in which write operations corresponding to 1 (one) block must be all performed every time write operation of 1 (one) page is performed, in the case where page to be written is page within the same block, and address order takes place in such a manner that it results in order backward (post-order) in succession, since copy of necessary page and write operation of the page to be written are repeated within one block, high speed write processing can be made.

Particularly, since determination is made such that write operation is performed in address number order, and in order from space (empty) page area of the order ahead with respect to data of character comments in the previously described area of “EXTERNAL”, the write control method according to the present invention is effectively exerted.

For example, in the case where character comments with respect to plural matters to be done are respectively inputted at the personal computer thereafter to write data of character comments with respect to those plural matters to be done into the flash memory 2, write operation of 1 (one) block unit had to be performed every each matter to be done of the charcter comment in the case of the prior art. However, in accordance with the present invention, since it becomes possible to sequentially write data of character comments corresponding to plural matters to be done into 1 (one) block in sequence, very high speed write operation can be realized.

Moreover, in the present invention, reset processing for coping with the fact that there results the state where write processing is not completed in the case where power supply voltage is interrupted for the reason such as power failure (interruption) and/or dying of battery, etc. in the middle of write processing as stated above is performed in a manner described below.

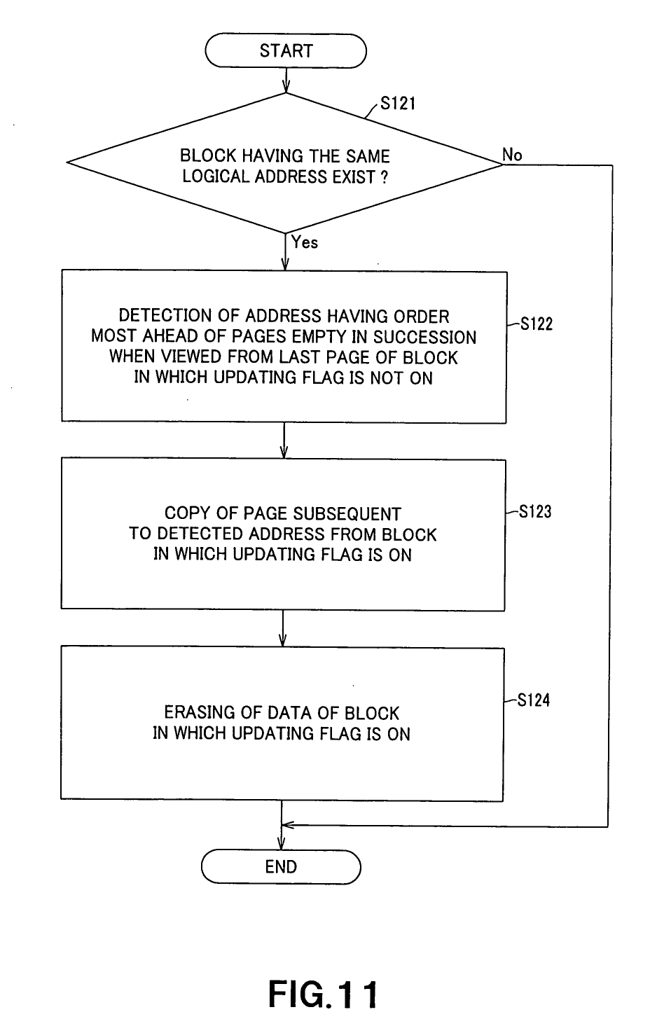

FIG. 11 is a flowchart for explaining reset processing when power supply voltage is turned ON for a second time in the present invention.

Namely, when power supply voltage is turned ON for a second time, the control unit 1 starts reset processing of FIG. 11 to first search logical addresses of spare areas of leading pages of respective blocks to discriminate whether or not two blocks of the same logical address exist (step S121).

As previously described above, since logical address on page data of original block to be rewritten which has been saved into the spare area from a logical point of view remains to be original logical address, there results the same state as that of the logical address of block of rewrite destination. Accordingly, when power supply is interrupted in the middle of write processing, two blocks in which logical address is the same would exist. It is to be noted that since updating flag is turned ON at original block to be rewritten, distinction from block of rewrite destination in which updating flag is in OFF state can be made.

When it is discriminated at step S121 on the basis of the above-mentioned facts that two blocks in which logical address is the same exist, the control unit 1 judges that power supply has been interrupted in the middle of write processing. In this embodiment, those both two blocks are left to search the inside of the block in which updating flag is in OFF state to detect page in which there results address of the order most ahead among pages which are empty in succession when viewed from page in which address order is the last of 1 (one) block (step S122).

Then, the control unit 1 all copies data of pages subsequent to the page of block in which updating flag is in ON state in a manner including detected page into corresponding page position of the block in which the updating flag is in OFF state (step S123). When copy has been completed, data of blocks in which updating flag is in ON state are all erased (step S124). Further, the reset processing is completed to shift to the subsequent processing.

Moreover, when it is discriminated at the step S121 that only one block in which logical address is the same exists, this reset processing is completed as it is under the judgment that there is no processing in which the write processing is being performed to shift to the subsequent processing.

Even when power supply is interrupted in the middle of write processing by the above-mentioned reset processing, data up to the written pages can be advantageously preserved even if plural pages are continuously written into one block.

It is to be noted that, as another example of the above-described reset processing, the inside of block in which updating flag is in OFF state may be searched at step S122, whereby in the case where page in which there results address of the order most ahead is detected among pages which are empty in succession when viewed from the page in which address order is the last, the page address position is registered as the subsequent write start position in block where the updating flag is in OFF state (write destination block) to complete the reset processing without performing processing of the steps S123 and S124 of FIG. 11.

In this case, by reset processing, there results the stage where the step S107 of FIG. 8 has been completed. Accordingly, after reset processing, there results the state where processing subsequent to step S111 of FIG. 9 are performed. When write operation has been completed, processing of the steps S112 and S113 which are equal to the processing of steps S123 and S124 of FIG. 11 are performed. Moreover, when write operation has not yet been completed, block and page which are subsequently written are discriminated to perform write processing as described above.

While the case where the recording medium is NAND type flash memory has been explained above, the present invention can be applied to all recording media which are required to perform address control similar to that of the NAND type flash memory at the time of write operation.

Moreover, it is a matter of course that the electronic equipment to which the present invention is applied is not limited to the IC recorder. Further, the flash memory is not limited to the flash memory included within electronic equipment, but, e.g., flash memory may be card type memory, and may be memory adapted so that it can be inserted or withdrawn.

Further, while, in the above-described explanation, space areas of block unit are prepared to perform write operation on page basis, distinction between block of write source and block of write destination is performed by using updating flag included in page data, distinction between block of write source and block of write destination is not limited to such a method using flag. For example, if block address of write source and block address of write destination are stored at all times to perform management thereof, distinction between blocks of write source and write destination can be made.

Further, while management of write control is performed by using logical/physical address conversion table in the above-described explanation, the present invention is not limited to such a method.

In addition, while explanation has been given in the above-described explanation in connection with the case where write operation is performed in ascending order in succession from page having small address (small block) within block (within large block), the present invention can be also similarly applied to the case where write operation is performed in descending order in succession from page having large address (small block).

### INDUSTRIAL APPLICABILITY

As described above, in the present invention, in the case where write instruction of page unit continuously takes place plural times with respect to page of address order within the same block, write operation of page unit is performed within the same block, and write operation of the block is then completed. Accordingly, it is possible to perform write processing at a high speed.

1. A recording control method for a recording medium in which small block having a predetermined number of data is caused to be unit of read/write operation of data, and large block consisting of the plural small blocks is caused to be unit of erasing operation of data so that write operation of the small blocks within the large block is performed in address order,
the recording control method comprising:
writing data into a first small block within the large block;
discriminating whether or not a second small block to be subsequently written has address order posterior to address of the first small block within the large block; and
writing data into the second small block when it is discriminated that the second small block has address order posterior to address of the first small block within the large block.

2. A recording control method for a recording medium in which small block having a predetermined number of data is caused to be unit of read/write operation of data, and large block consisting of the plural small blocks is caused to be unit of erasing operation of data so that write operation of the small blocks within the large block is performed in address order,
the recording control method comprising:
a first copying step of copying small block having address order prior to address of a first small blocks at a first large block within which the first small block is included into corresponding address of a second large block in which data has been erased;
a first writing step of writing data into address coreesonding to address of the first small block of the second large block;
a discrimination step of discriminating whether or not a second small block to be subsequently written has address order posterior to address of the first small block within the first large block;
a second copying step in which when it is discriminated at the discrimination step that the second small block has address order posterior to address of the first small block within the first large block, data of the small block between the first small block and the second small block is copied into corresponding address of the second large block;
a second writing step of writing data into address corresponding to address of the second small block of the second large block after the second copying step;
a third copying step in which when it is discriminated at the discrimination step that the second small block is small block within a large block different from the first large block, data of all small blocks having address order posterior to address of the first small block within the first large block are copied into corresponding address of the second large block; and
an erasing step of erasing data of the first block after the third copying step.

3. The recording control method for recording medium as set forth in claim 2,
wherein processing returns to the discrimination step after the second writing step to perform processing subsequent to the discrimination step.

4. The recording control method for recording medium as set forth in claim 2, further comprising, at the time of return operation after write processing has been interrupted on the way,
a step of detecting small block address having order most ahead among small block addresses which are empty in succession when viewed from small block address where the address order is the last within the second large block,
a step of copying data of corresponding small block of the first large block into all small block addresses subsequent to the small block address having the order most ahead of the second large block, and
an erasing step of erasing data of the first large block.

5. The recording control method for recording medium as set forth in claim 2,
wherein, at the time of return operation after write operation of the small block unit is interrupted on the way, small block address having order most ahead among large block addresses which are empty in succession when viewed from small block address in which the address order is the last of the second large block is caused to be small block address where write operation is to be subsequently started within the second large block.

6. A recording control apparatus for a recording medium in which small block having a predetermined number of data is caused to be unit of read/write operation of data, and large block consisting of the plural small blocks is caused to be unit of erasing operation of data so that write operation of the small blocks within the large block is performed in address order,
the recording control apparatus comprising:
discriminating means adapted so that when write operation of data into a first small block within the large block is completed, the discriminating means serves to discriminate whether or not a second small block to be subsequently written is small block within the large block, and has address order posterior to address of the first small block,
whereby when it is discriminated at the discriminating means that the second small block is small block within the first large block, and has address order posterior to address of the first small block, write operation of data is performed into the second small block.

7. A recording control apparatus for a recording medium in which small block having a predetermined number of data is caused to be unit of read/write operation of data, and large block consisting of the plural small blocks is caused to be unit of erasing operation of data so that write operation of the small blocks within the large block is performed in address order,
the recording control apparatus comprising:
first copying means for copying small block having address order prior to address of a first small block at a first large block within which the first small block is included into address corresponding to a second large block in which data has been erased;
first writing means for writing data into address corresponding to address of the first small block within the second large block;
discriminating means for discriminating whether or not a second small block to be subsequently written has address order posterior to address of the first small block within the first large block;
second copying means adapted so that when it is discriminated by the discriminating means that the second small block has address order posterior to address of the first small block within the first large block, the second copying means serves to copy small block data between the first small block and the second small block into corresponding address of the second large block;
second writing means for writing data into address corresponding to address of the second small block within the second large block in which copy has been made by the second copying means;
third copying means adapted so that when it is discriminated by the discriminating means that the second small block is small block within a large block different from the first large block, the third copying means serves to copy all small block data having address order posterior to address of the first small block within the first large block into corresponding address of the second large block; and
erasing means for erasing data of the first block after copy processing at the third copying means.

8. The recording control apparatus for recording medium as set forth in claim 7,
wherein discrimination by the discriminating means is performed for a second time after data write operation by the second writing means.

9. The recording control apparatus for recording medium as set forth in claim 7, further comprising:
detecting means for detecting that write operation of the small block unit has been interrupted on the way;
means adapted so that when it is detected by the detecting means that when write operation of the small block unit has been interrupted on the way, the last-mentioned means detects small block address having order most ahead among small block addresses which are empty in succession when viewed from small block address in which the address order is the last within the second large block;
copying means for copying data of corresponding small block of the first large block into all small block addresses subsequent to the small block address having the order most ahead of the second large block; and
erasing means for erasing data of the first large block.

10. The recording control apparatus for recording medium as set forth in claim 7, comprising detecting means for detecting that write operation of the small block unit has been interrupted on the way, whereby when it is detected by the detecting means that write operation of the small block unit has been interrupted on the way, small block address having order most ahead among small block addresses which are empty in succession when viewed from small block address in which address order is the last of the second large block is caused to be small block address in which write operation is to be subsequently started within the second large block.
